(19) United States
(12) Patent Application Publication
(10) Pub. No.: US 2026/0162045 A1
(43) Pub. Date: Jun. 11, 2026

(54) EVALUATION SYSTEM AND METHOD FOR ENHANCING THE PARTICIPATION RATE OF MYCOPLASMA PNEUMONIAE DETECTION THROUGH RELAY INSPECTION

(71) Applicant: WUXI CENTER FOR DISEASE CONTROL AND PREVENTION, Wuxi (CN)

(72) Inventors: Chao SHI, Wuxi (CN); Yuan SHEN, Wuxi (CN); Mingyan LU, Wuxi (CN); Yan WANG, Wuxi (CN)

(73) Assignee: WUXI CENTER FOR DISEASE CONTROL AND PREVENTION, Wuxi (CN)

(21) Appl. No.: 19/415,722

(22) Filed: Dec. 10, 2025

(30) Foreign Application Priority Data
Dec. 11, 2024 (CN) 202411820761.1

(51) Int. Cl. G06Q 10/0639; G06N 20/00; G06Q 10/0631

(52) U.S. Cl. CPC G06Q 10/06398; G06N 20/00; G06Q 10/06311

(57) ABSTRACT

An evaluation system and method for enhancing a participation rate of Mycoplasma pneumoniae detection through relay inspection are provided. The system includes: a data collection module; a data preprocessing module; a model training module; an evaluation import module configured to acquire an evaluation result output by a participation rate evaluation model and import the evaluation result into an evaluation database for clustering segmentation; and a task assignment module. The task assignment module is configured to construct a mapping relationship based on a person segmentation level and a clustering label; obtain preset assignment information of a relay inspection task; parse feature information of the relay inspection task; use the feature information as a search target to perform correlation analysis on the person segmentation level and the clustering label; filter out research staff having a highest correlation with the relay inspection task; and adjust the research staff in the preset assignment information.

### CROSS-REFERENCE TO RELATED APPLICATIONS

This application claims priority to the Chinese Patent Application No. 202411820761.1, filed on Dec. 11, 2024, the contents of which are hereby incorporated by reference.

### TECHNICAL FIELD

The present disclosure relates to the field of data analysis, and in particular to an evaluation system and method for enhancing the participation rate of Mycoplasma pneumoniae detection through relay inspection.

### BACKGROUND

Mycoplasma pneumoniae detection is critical for the prevention and control of respiratory diseases. Its quality directly impacts clinical diagnosis and public health outcomes. Evaluating and improving the participation rate of inspection personnel is a key factor in ensuring inspection quality and efficiency. A relay inspection technique, through a “free testing+public welfare donation” mode, may significantly increase participation in various health inspections. However, when this mode is applied to the Mycoplasma pneumoniae detection, it struggles to meet practical needs regarding effectively evaluating and intelligently enhancing participation in the Mycoplasma pneumoniae detection.

Currently, techniques for evaluating the participation rate of inspection personnel primarily rely on manual statistics and judgment. On one hand, manual analysis requires processing massive amounts of personnel information and historical data. This is not only time-consuming and labor-intensive but also prone to errors that compromise the evaluation results, making it difficult to objectively and comprehensively reflect the actual capabilities and participation potential of research staff. By focusing only on metrics such as inspection participation, inspection frequency, and task completion status, this evaluation approach overlooks crucial quality aspects like inspection duration, reasonableness, and abnormal report rate. As a result, it fails to ensure an accurate reflection of participation rate and leads to a low matching degree between personnel and task requirements. On the other hand, this mode exhibits an over-reliance on the historical performance of the research staff and the personal experience of an assigner, forming a rigid assignment pattern where “fixed personnel undertake fixed types of tasks.” That is, research staff with strong capabilities repeatedly take on high-priority tasks, leaving them little room for breakthroughs and improvement. In contrast, research staff with potential but limited prior participation opportunities struggle to obtain suitable tasks, hindering their growth paths and ultimately restricting the overall vitality and innovation capacity of the entire research team.

Furthermore, although the relay inspection technique can enhance inspection participation, the lack of a scientific evaluation and an intelligent assignment mechanism in the context of the Mycoplasma pneumoniae detection makes it difficult to accurately match tasks based on personnel regional features, capabilities, and demands. This not only restricts participation enthusiasm but also limits its potential as a growth opportunity.

In summary, the existing task assignment mode relying on manual evaluation has problems such as low accuracy, low efficiency, and inhibiting personnel growth, which restricts detection quality and participation. Therefore, there is an urgent need to establish a data-driven intelligent evaluation and allocation scheme. By systematically analyzing the multi-dimensional characteristics of personnel, it realizes the quantitative evaluation of participation rate and the precise matching of tasks, so as to overcome the limitations of manual work, promote the growth of the research staff, and thus improve the overall efficiency of the Mycoplasma pneumoniae detection.

### SUMMARY

The present disclosure provides an evaluation system and method for enhancing the participation rate of Mycoplasma pneumoniae detection through relay inspection, aiming to solve the technical problem in the prior art of lacking an effective method to evaluate and intelligently improve the participation rate in Mycoplasma pneumoniae detection.

In view of the above problems, the present disclosure provides an evaluation system and method for enhancing the participation rate of Mycoplasma pneumoniae detection through relay inspection.

One or more embodiments of the present disclosure provide an evaluation system for enhancing the participation rate of Mycoplasma pneumoniae detection through relay inspection, including: a data collection module configured to collect behavioral data of research staff, wherein the behavioral data includes at least one of an inspection duration, an inspection frequency, a task completion status, and an abnormal report rate; a data preprocessing module configured to perform preprocessing on the behavioral data, construct a training dataset, and segment the training dataset to determine training data and test data; a model training module, configured to generate a participation rate evaluation model by performing model training and model testing using the training data and the test data based on a machine learning algorithm, wherein the participation rate evaluation model is configured to determine an evaluation result based on the behavioral data; an evaluation import module configured to: acquire the evaluation result output by the participation rate evaluation model, import the evaluation result into an evaluation database, determine a person segmentation level by performing first clustering on corresponding research staff in the evaluation database, wherein the person segmentation level includes at least one of a high participation rate, a medium participation rate, and a low participation rate, and determine a clustering label by performing second clustering on the person segmentation level based on a research location, age, a household income, and a parental education level; and a task assignment module configured to: construct a first mapping relationship based on the person segmentation level and the clustering label, send the first mapping relationship to a management interface of a relay inspection task, obtain preset assignment information of the relay inspection task, wherein the preset assignment information includes at least one of a quantity, a type, a difficulty, and a time schedule of the relay inspection task, parse feature information of the relay inspection task, wherein the feature information includes at least one of a regional feature, a difficulty feature, and a support demand feature, filter out research staff having a highest correlation with the relay inspection task by performing correlation analysis on the person segmentation level and the clustering label using the feature information as a first search target, and adjust research staff in the preset assignment information by using the filtered research staff.

One or more embodiments of the present disclosure provide an evaluation method for enhancing the participation rate of Mycoplasma pneumoniae detection through relay inspection, executed by an evaluation system for enhancing the participation rate of Mycoplasma pneumoniae detection through relay inspection, including: collecting behavioral data of research staff, wherein the behavioral data includes at least one of an inspection duration, an inspection frequency, a task completion status, and an abnormal report rate; performing preprocessing on the behavioral data, constructing a training dataset, and segmenting the training dataset to determine training data and test data; generating a participation rate evaluation model by performing model training and model testing using the training data and the test data based on a machine learning algorithm, wherein the participation rate evaluation model is configured to determine an evaluation result based on the behavioral data; acquiring the evaluation result output by the participation rate evaluation model; importing the evaluation result into an evaluation database, and determining a person segmentation level by performing first clustering on corresponding research staff in the evaluation database, wherein the person segmentation level includes at least one of a high participation rate, a medium participation rate, and a low participation rate; determining a clustering label by performing second clustering on the person segmentation level based on a research location, age, a household income, and a parental education level; constructing a first mapping relationship based on the person segmentation level and the clustering label, and sending the first mapping relationship to a management interface of a relay inspection task; acquiring preset assignment information of the relay inspection task, wherein the preset assignment information includes at least one of a quantity, a type, a difficulty, and a time schedule of the relay inspection task; parsing feature information of the relay inspection task, wherein the feature information includes at least one of a regional feature, a difficulty feature, and a support demand feature; filtering out research staff having a highest correlation with the relay inspection task by performing correlation analysis on the person segmentation level and the clustering label using the feature information as a first search target; and adjusting research staff in the preset assignment information by using the filtered research staff.

### BRIEF DESCRIPTION OF THE DRAWINGS

FIG. 1 is a schematic diagram illustrating a structure of an evaluation system for enhancing a participation rate of Mycoplasma pneumoniae detection through relay inspection according to some embodiments of the present disclosure;

FIG. 2 is a flowchart illustrating an exemplary evaluation process for enhancing a participation rate of Mycoplasma pneumoniae detection through relay inspection according to some embodiments of the present disclosure;

FIG. 3 is a schematic diagram illustrating an implementation mode of a relay inspection task according to some embodiments of the present disclosure;

FIG. 4 is a flowchart illustrating an exemplary process for determining a target assignment scheme according to some embodiments of the present disclosure;

FIG. 5 is a flowchart illustrating an exemplary process for determining a target assignment scheme according to other embodiments of the present disclosure;

FIG. 6 is a schematic diagram illustrating a process for sending assignment information according to some embodiments of the present disclosure; and

FIG. 7 is a flowchart illustrating an exemplary process for entering a target inspection vehicle and operating an inspection instrument according to some embodiments of the present disclosure.

### DETAILED DESCRIPTION

The overall idea of the technical solution provided in the present disclosure is as follows.

Embodiments of the present disclosure provide an evaluation system and method for enhancing the participation rate of Mycoplasma pneumoniae detection through relay inspection, which achieve objective evaluation of inspection participation rate and optimal task assignment through data-driven and machine learning technologies. A modular design is adopted, and full-process automation from data collection to task assignment is achieved through the collaboration of a plurality of functional modules.

First, behavioral data of research staff is obtained through a data collection module, including multi-dimensional information such as an inspection duration, an inspection frequency, a task completion status, and an abnormal report rate. Subsequently, a data preprocessing module performs preprocessing on the behavioral data to construct a high-quality training dataset. On this basis, a model training module utilizes a machine learning algorithm, and through repeated learning of training data and test data, converges to obtain a participation rate evaluation model capable of quantitatively evaluating a plurality of indicators of the research staff. The evaluation result is systematically managed through an evaluation import module and used for clustering and segmentation of the research staff. Afterwards, a task assignment module achieves intelligent adjustment and assignment of inspection tasks based on the evaluation result and a clustering result.

After introducing the basic principles of the present disclosure, various non-limiting embodiments of the present disclosure will be specifically introduced below in conjunction with the drawings of the specification.

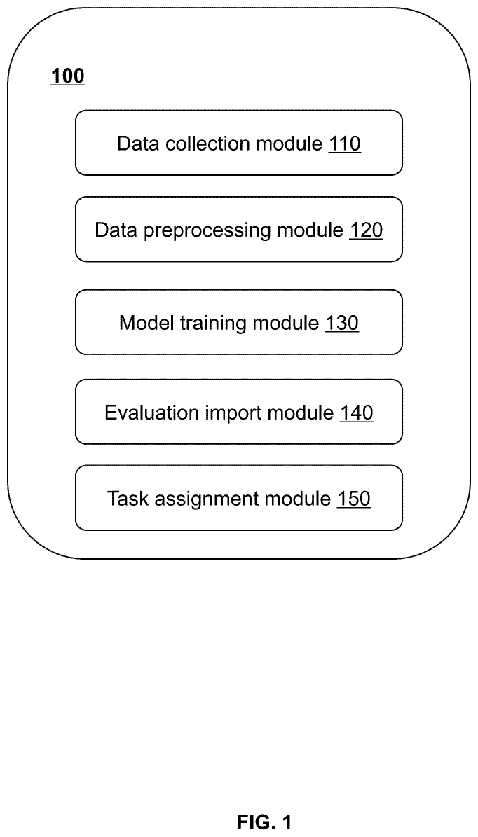

FIG. 1 is a schematic diagram illustrating a structure of an evaluation system for enhancing a participation rate of Mycoplasma pneumoniae detection through relay inspection according to some embodiments of the present disclosure.

As shown in FIG. 1, some embodiments of the present disclosure provide an evaluation system for enhancing a participation rate of Mycoplasma pneumoniae detection through relay inspection (hereinafter referred to as the system) 100, which includes a data collection module 110, a data preprocessing module 120, a model training module 130, an evaluation import module 140, and a task assignment module 150.

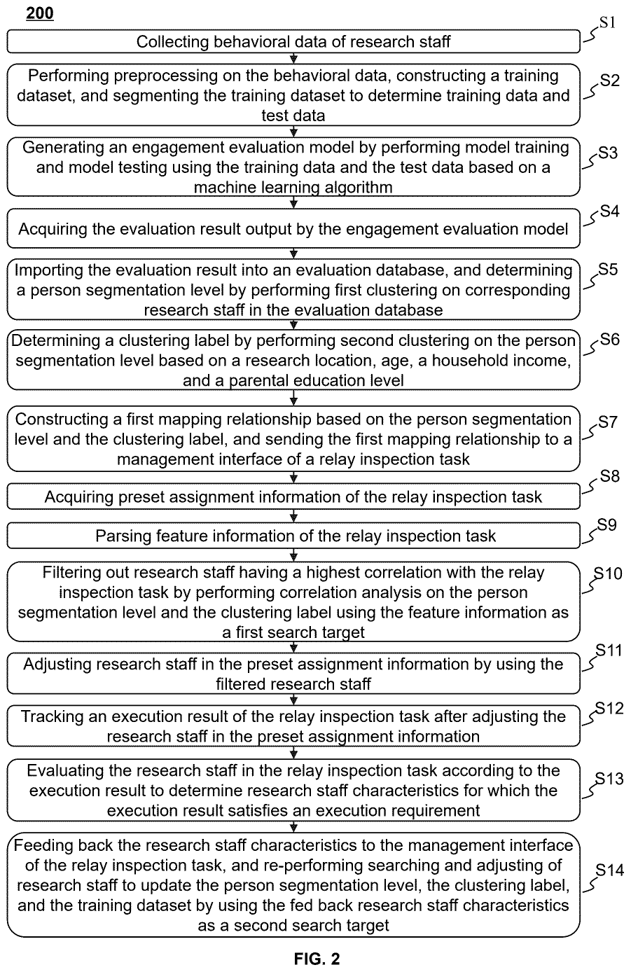

In some embodiments, the data collection module 110 is configured to collect behavioral data of research staff. The behavioral data includes at least one of an inspection duration, an inspection frequency, a task completion status, and an abnormal report rate. More descriptions of the behavioral data may be found in FIG. 2 and related descriptions.

The data collection module 110 refers to a module configured to collect the behavioral data of the research staff during a Mycoplasma pneumoniae detection process. For example, the data collection module 110 may include a terminal device, a server, a gateway, etc.

In some embodiments, the data preprocessing module 120 is configured to perform preprocessing on the behavioral data, construct a training dataset, and segment the training dataset to determine training data and test data.

The data preprocessing module 120 refers to a module configured to perform cleaning, formatting, and normalization processing on collected behavioral data. For example, the data preprocessing module 120 may include a server, a graphics processor, etc.

In some embodiments, the data preprocessing module 120 is further configured to: perform missing value processing and outlier processing on the behavioral data, and perform data format normalization on the behavioral data from different sources to complete the preprocessing of the behavioral data; establish a second mapping relationship between the evaluation result and the inspection duration, as well as the inspection frequency, the task completion status, and the abnormal report rate based on the preprocessed behavioral data; and construct the training dataset based on the second mapping relationship.

In some embodiments, the data preprocessing module 120 is further configured to: fill missing values in the behavioral data based on a mode value corresponding to the behavioral data to complete the missing value processing; delete outliers in the behavioral data after the missing value processing to complete the outlier processing; perform continuity analysis on the behavioral data after the outlier processing; and in response to the behavioral data after the continuity analysis having a missing value, complete the missing value processing based on the mode value corresponding to the behavioral data.

In some embodiments, the model training module 130 is configured to generate a participation rate evaluation model by performing model training and model testing using the training data and the test data based on a machine learning algorithm. The participation rate evaluation model is configured to determine an evaluation result based on the behavioral data

The model training module 130 refers to a module configured to perform model learning and optimize model parameters using data. For example, the model training module 130 may include a GPU server, a server cluster, etc.

In some embodiments, the model training module 130 is further configured to: construct a support vector machine, select a kernel function and a kernel parameter, set a penalty parameter, and train the support vector machine using the training data to obtain a trained support vector machine; perform an accuracy test on the trained support vector machine using the test data to determine a test result; and adjust the kernel parameter and the penalty parameter according to the test result, iteratively train the trained support vector machine until the test result reaches a target value to obtain the participation rate evaluation model.

In some embodiments, the evaluation import module 140 is configured to acquire the evaluation result output by the participation rate evaluation model; import the evaluation result into an evaluation database, and determine a person segmentation level by performing first clustering on the corresponding research staff in the evaluation database, wherein the person segmentation level includes at least one of a high participation rate, a medium participation rate, and a low participation rate; and determine a clustering label by performing second clustering on the person segmentation levels based on a research location, age, a household income, and a parental education level.

The evaluation import module 140 refers to a module configured to import the evaluation result output by the participation rate evaluation model and perform clustering analysis on the research staff. For example, the evaluation import module may include a database server, a memory, etc.

In some embodiments, the task assignment module 150 is configured to: construct a first mapping relationship based on the person segmentation level and the clustering label, and send the first mapping relationship to a management interface of a relay inspection task; obtain preset assignment information of the relay inspection task, wherein the preset assignment information includes at least one of a quantity, a type, a difficulty, and a time schedule of the relay inspection task; parse feature information of the relay inspection task, wherein the feature information includes at least one of a regional feature, a difficulty feature, and a support demand feature; filter out research staff having a highest correlation with the relay inspection task by performing correlation analysis on the person segmentation level and the clustering label using the feature information as a first search target; and adjust research staff in the preset assignment information by using the filtered research staff.

The task assignment module 150 refers to a module configured to reasonably assign the relay inspection task to appropriate research staff. For example, the task assignment module may include a task management platform, a router, a switch, etc.

In some embodiments, the task assignment module 150 is further configured to: track an execution result of the relay inspection task after adjusting the research staff in the preset assignment information; evaluate the research staff in the relay inspection task according to the execution result to determine research staff characteristics for which the execution result satisfies an execution requirement; and feed back the research staff characteristics to the management interface of the relay inspection task, and re-perform searching and adjusting of research staff to update the person segmentation level, the clustering label, and the training dataset by using the fed back research staff characteristics as a second search target.

In some embodiments, the task assignment module 150 is further configured to: perform the correlation analysis on the person segmentation level and the clustering label to determine a correlation analysis result by using the feature information as the first search target; determine a plurality of groups of candidate assignment schemes for a target task based on the correlation analysis result and task information; for each group of the plurality of groups of candidate assignment schemes, determine a matching degree based on the correlation analysis result and the task information; determine a team gain through a graph model based on a collaborative network map, wherein the graph model is a machine learning model; determine a comprehensive score based on the matching degree and the team gain; and determine a target assignment scheme based on the comprehensive score of each group of the plurality of groups of candidate assignment schemes.

In some embodiments, the task assignment module 150 is further configured to determine the matching degree through a prediction model based on the task information, the person segmentation level, the clustering label, and a four-quadrant state. The prediction model is a machine learning model.

In some embodiments, the task assignment module 150 is further configured to determine a plurality of optimal assignment schemes based on the comprehensive score; for each optimal assignment scheme, search a personnel profile database for an inspection terminal sequence corresponding to research staff in each optimal assignment scheme; send a positioning request to a corresponding inspection terminal based on the inspection terminal sequence to obtain a current location of the research staff; determine a location matching degree based on the current location of the research staff and a task execution location; and determine the target assignment scheme based on the location matching degree of each optimal assignment scheme.

In some embodiments, the task assignment module 150 is further configured to: search a personnel profile database for contact information of an assigned person based on a target assignment scheme, wherein the assigned person refers to research staff corresponding to the target assignment scheme; and send assignment information to the assigned person based on the contact information of the assigned person.

In some embodiments, the task assignment module 150 is further configured to: select a target inspection vehicle from an inspection vehicle database based on a current location of the assigned person and a task execution location, wherein a vehicle location of the target inspection vehicle satisfies a distance condition; send an authorization instruction to an access control system of the target inspection vehicle to change an entry permission of the assigned person from closed to open, thereby authorizing the assigned person to enter the target inspection vehicle; and send a configuration instruction to an inspection instrument in the target inspection vehicle to change an operation permission of the assigned person from closed to open, thereby authorizing the assigned person to operate the inspection instrument.

Through the intelligent assignment of the task assignment module 150, efficient assignment and execution of a relay inspection task can be achieved, improving overall inspection efficiency and quality. Meanwhile, appropriate incentives can be given based on the performance of the research staff, forming a virtuous cycle inspection ecosystem.

In some embodiments, the system 100 may further include a processor (not shown in FIG. 1). The data collection module 110, the data preprocessing module 120, the model training module 130, the evaluation import module 140, and the task assignment module 150 in the system 100 may be partially/entirely integrated into the processor.

The processor may include a central processing unit (CPU), an application-specific integrated circuit (ASIC), an application-specific instruction processor (ASIP), or the like, or any combination thereof.

More descriptions of the system 100 may be found in FIG. 2-FIG. 7 and related descriptions.

The system 100 collects the behavioral data of the research staff through the data collection module 110, thereby obtaining comprehensive raw data and providing a foundation for subsequent analysis. The system 100 performs preprocessing on the collected behavioral data through the data preprocessing module 120, constructs the training dataset, and segments the training dataset to determine the training data and the test data, ensuring data quality and preparing for the model training. The system 100 performs the model training and the model testing based on the machine learning algorithm using the training data and the test data through the model training module 130, and converges to obtain the participation rate evaluation model. The system 100 obtains the evaluation result output by the participation rate evaluation model through the evaluation import module 140, imports the evaluation result into the evaluation database, performs the first clustering on corresponding research staff in the evaluation database, systematically manages the evaluation result, and classifies the research staff. The system 100 adjusts and assigns the relay inspection task according to the person segmentation level and the clustering label through the task assignment module 150, solving the technical problem of lacking an effective method to evaluate and intelligently improve the participation rate in the Mycoplasma pneumoniae detection, and achieving the technical effect of quantitatively evaluating the participation rate of research staff through a data-driven machine learning model and optimizing task assignment accordingly, thereby improving the overall efficiency and quality of Mycoplasma pneumoniae detection.

FIG. 2 is a flowchart illustrating an exemplary evaluation process for enhancing a participation rate of Mycoplasma pneumoniae detection through relay inspection according to some embodiments of the present disclosure.

As shown in FIG. 2, the process 200 includes steps S1-S14. In some embodiments, the process 200 may be executed by a processor.

In S1, behavioral data of research staff is collected.

The research staff (also referred to as the research population) consists of individuals who participate in the execution of the relay inspection task and generate related behavioral data.

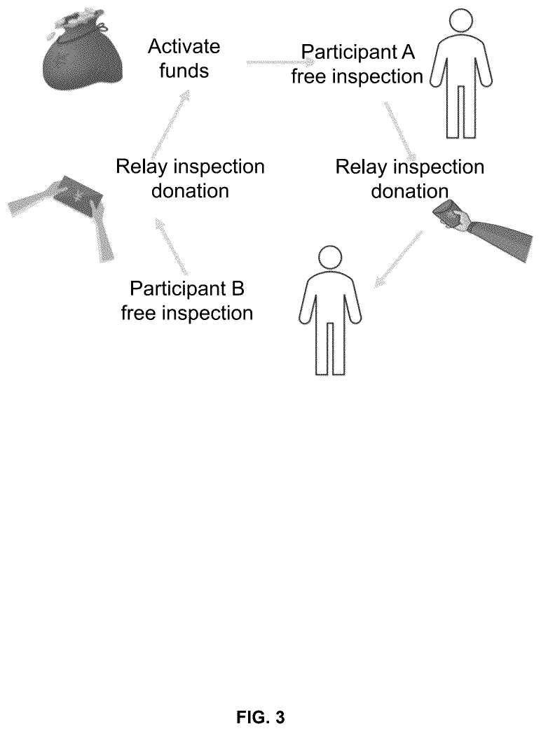

FIG. 3 is a schematic diagram illustrating an implementation mode of a relay inspection task according to some embodiments of the present disclosure.

As shown in FIG. 3, a relay inspection task involves providing individuals with free health inspections, informing them that their fees have been kindly covered by someone else, and asking if they are willing to donate to help fund free health inspection services for others. The relay inspection task includes an inspection task, a Mycoplasma pneumoniae detection task, etc.

The behavioral data refers to raw indicators generated by the research staff during the execution of the relay inspection task and used to quantify their work.

In some embodiments, the behavioral data includes at least one of an inspection duration, an inspection frequency, a task completion status, and an abnormal report rate.

The inspection duration refers to the time required for each research staff to complete a single relay inspection task, measured in minutes.

The inspection frequency refers to a total count of relay inspection tasks completed by each research staff member within a preset time period. A length of the preset time period may be preset by a person skilled in the art based on experience. For example, the preset time period may be one week, one month, etc.

The task completion status refers to whether the research staff completes all assigned relay inspection tasks according to a predetermined plan. The task completion status may be represented by a percentage of completed tasks to total tasks.

The abnormal report rate refers to a proportion of detection reports submitted by the research staff that contain detection abnormalities or errors. For example, situations in which the detection reports contain abnormalities or errors include format errors, data recording mistakes (e.g., incorrect recording of key information such as detection time or results), and the use of incorrect detection methods or devices.

In some embodiments, a calculation manner for the abnormal report rate may be a count of abnormal reports divided by a total count of reports.

In some embodiments, the behavioral data may further include historical multi-dimensional capability data and historical task difficulty.

The historical multi-dimensional capability data refers to capability level data of the research staff in different dimensions over time, recorded through tests or quantitative evaluations.

The historical task difficulty refers to the difficulty level data preset or assessed post-hoc for past tasks executed by the research staff.

The historical multi-dimensional capability data and the historical task difficulty may be determined based on historical data.

In some embodiments, the processor may obtain the behavioral data in a plurality of ways, for example, through automatic recording by inspection equipment, manual input by the research staff, questionnaires, etc. The behavioral data obtained by the processor provides a foundation for subsequent participation rate evaluation, helping to comprehensively understand the performance and participation rate of the research staff during the Mycoplasma pneumoniae detection process.

In S2, preprocessing is performed on the behavioral data, a training dataset is constructed, and the training dataset is segmented to determine training data and test data.

In some embodiments, the processor preprocesses the collected behavioral data. The preprocessing includes operations such as missing value processing, outlier processing, and data format normalization, aiming to improve data quality and ensure accuracy and reliability of subsequent analysis.

The missing value processing refers to an operation of identifying null or unrecorded fields in the behavioral data and filling them. For missing values, a plurality of strategies are adopted, such as filling using a mean value, a median value, or a mode value of corresponding features in the behavioral data, or using more complex interpolation methods. For example, for a missing value in the inspection duration, a mode value of the inspection duration of the research staff in historical relay inspection tasks or a mean value of historical inspection durations may be used for filling. As another example, for a missing value in the inspection frequency, if most research staff perform inspections 3 times within a week, then for the missing value in the inspection frequency, 3 may be used for filling, which can better reflect a central tendency of the data and reduce bias introduced by filling.

The outlier processing refers to an operation of identifying outliers in the behavioral data that deviate from a normal range and correcting them according to actual situations. For example, for an obviously unreasonable outlier, such as a negative inspection frequency, it may be deleted. As another example, by having technical personnel preset a reasonable threshold range in advance, the processor treats the behavioral data exceeding the threshold range as outliers and processes them, such as by deletion or setting them to boundary values of the threshold range.

In some embodiments, determination of the outliers may be based on preset rules or statistical methods, such as the 3σ principle or the Interquartile Range (IQR) process.

The data format normalization refers to an operation of converting the behavioral data from diverse sources and inconsistent structures into a standardized, unified format that can be directly processed by the system.

Since the behavioral data may come from multiple channels, such as automatically recorded data from inspection equipment, manually input data from the research staff, questionnaire data, etc., the data format normalization operation ensures consistency and comparability of the behavioral data, facilitating subsequent calculation and analysis.

It is known that the behavioral data after continuity analysis exists in two situations: with the missing values and without the missing values.

In some embodiments, the processor is further configured to: fill the missing values in the behavioral data based on the mode value corresponding to the behavioral data to complete the missing value processing; delete the outliers in the behavioral data after the missing value processing to complete the outlier processing; perform the continuity analysis on the behavioral data after the outlier processing; and in response to the behavioral data after the continuity analysis having the missing value, complete the missing value processing based on the mode value corresponding to the behavioral data.

The continuity analysis refers to a process of performing sequential coherence checks on the behavioral data after the outlier processing to identify sequence interruptions or logical discontinuities caused by complete data absence.

In some embodiments, when performing the continuity analysis, the processor first checks the behavioral data from which the outliers have been deleted and determines whether the deletion operation has caused new missing values. If the new missing values are found during the continuity analysis, a filling mechanism based on the mode value is re-initiated to ensure the continuity and integrity of the behavioral data, thereby providing a high-quality data foundation for subsequent model training.

First, for the missing values in the behavioral data, the processor uses a corresponding mode value for filling, thus discrete characteristics of the data can be maintained, which is particularly suitable for categorical variables or discrete numerical variables, thereby better reflecting a central tendency of the data and reducing bias introduced by filling. Second, a data preprocessing module performs outlier deletion processing on the outliers in the behavioral data. For example, if the inspection duration of the research staff far exceeds a normal range, the inspection duration is identified as the outlier and deleted from the training dataset to remove extreme data points that may affect accuracy of model training. After completing outlier deletion, the data preprocessing module performs the continuity analysis to check whether the outlier deletion has caused new data absence or discontinuity. If it is found that the behavioral data have new missing values after deleting the outliers, the mode value filling method is used again for processing. This iterative processing approach ensures the integrity and continuity of the data.

The training dataset refers to a data collection configured for training a participation rate evaluation model.

In some embodiments, the processor integrates the preprocessed behavioral data to construct the training dataset.

In some embodiments, the data preprocessing module is configured to perform the missing value processing and the outlier processing on the behavioral data, and perform the data format normalization on the behavioral data from different sources to complete the preprocessing of the behavioral data; establish a second mapping relationship between the evaluation result and the inspection duration, as well as the inspection frequency, the task completion status, and the abnormal report rate based on the preprocessed behavioral data; and construct the training dataset based on the second mapping relationship.

The evaluation result refers to an indicator configured to characterize the participation rate of the research staff in a relay inspection task. For example, the evaluation result includes a participation rate score, a participation rate.

In some embodiments, the evaluation result may be a quantified score or level, reflecting the participation rate of the research staff during the Mycoplasma pneumoniae detection process. For example, the evaluation result may be represented by a score from 0 to 100, indicating the participation rate of the research staff throughout the detection process. As another example, the evaluation result may adopt a level system, such as three levels: “Level A,” “Level B,” and “Level C.”

More descriptions of how to determine the evaluation result may be found in step S2 or step S3 and related descriptions.

In some embodiments, after preprocessing the behavioral data is completed, the processor establishes the second mapping relationship between the evaluation result and the inspection duration, as well as the inspection frequency, the task completion status, and the abnormal report rate based on the preprocessed behavioral data.

The second mapping relationship refers to a supervised learning relationship from the behavioral data to the evaluation result used to guide the machine learning model.

In some embodiments, during the process of constructing the training dataset, the processor may establish the second mapping relationship between the evaluation result and features such as the inspection duration, the inspection frequency, the task completion status, the abnormal report rate, etc., based on expert experience, historical data analysis, or predefined rules. Merely by way of example, the processor may determine the evaluation result based on a positive correlation relationship between the evaluation result and the inspection duration, as well as the inspection frequency and the task completion status, and a negative correlation relationship between the evaluation result and the abnormal report rate. For example, through a preset weighted formula, different weights are assigned to indicators (e.g., the inspection duration, the inspection frequency, the task completion status, the abnormal report rate) according to their importance (preset by professional technical personnel), and the evaluation result is comprehensively calculated, thereby constructing the second mapping relationship between the evaluation result and the inspection duration, as well as the inspection frequency, the task completion status, the abnormal report rate, etc.

In some embodiments, the processor constructs the training dataset based on the second mapping relationship. For example, the processor uses the preprocessed behavioral data corresponding to each research staff as the input feature, and the evaluation result, calculated according to the second mapping relationship, as the label corresponding to the input feature. Then, the processor combines a plurality of “input feature-label” pairs to form the training dataset.

The processor, through the above-mentioned refined data preprocessing process, is able to more effectively handle various data issues that may arise during the actual detection process, providing high-quality data inputs for subsequent model training, thereby improving the accuracy and reliability of participation rate assessment.

In some embodiments, the processor splits the constructed training dataset to determine the training data and the test data. For example, the processor may use a random sampling method to divide the entire training dataset into the training data and the test data according to a preset ratio (such as 7:3 or 8:2, etc.). The training data is configured for model learning and parameter adjustment, and the test data is configured to evaluate the performance and generalization ability of the model.

In S3, the participation rate evaluation model is generated by performing the model training and the model testing using the training data and the test data based on a machine learning algorithm.

The participation rate evaluation model refers to a model configured to perform quantified participation rate evaluation on a plurality of indicators of the research staff as input. In some embodiments, the participation rate evaluation model is configured to determine the evaluation result based on the behavioral data.

In some embodiments, the participation rate evaluation model is a machine learning model. For example, the participation rate evaluation model includes one or a combination of a support vector machine (SVM) model, a random forest (RF) model, or other customized models.

In some embodiments, the processor may select an appropriate machine learning algorithm as the foundation. For example, the processor selects the support vector machine as the core algorithm, and selects an appropriate kernel function (such as the radial basis function (RBF), etc.). After selecting the algorithm, the processor uses the training data to train an initial participation rate evaluation model (i.e., the aforementioned selected support vector machine). During the training process, the initial participation rate evaluation model continuously adjusts its internal parameters, for example, adjusts the kernel parameter (such as the y value) and the penalty parameter (such as the C value), etc., to minimize the error between the prediction result and the actual result, thereby obtaining the trained participation rate evaluation model.

In some embodiments, the processor is further configured to: construct the support vector machine, and select the kernel function and the kernel parameter, set the penalty parameter, train the support vector machine using the training data; perform an accuracy test on the trained support vector machine using the test data, determine a test result; according to the test result, adjust the kernel parameter and the penalty parameter, iteratively train the trained support vector machine, until the test accuracy reaches a target value, and obtain the participation rate evaluation model.

The target value may be set by those skilled in the art based on experience. For example, the target value may be 90%, 95%, etc.

In some embodiments, the participation rate evaluation model is capable of receiving the plurality of indicators of the research staff as input, including but not limited to the inspection duration, the inspection frequency, the task completion status, the abnormal report rate, etc., and outputting a quantified evaluation result.

In some embodiments, the processor constructs the support vector machine and uses it as the core algorithm. When constructing the support vector machine, the processor selects the kernel function and a corresponding kernel parameter. For example, the kernel function may include a linear kernel, a polynomial kernel, and a radial basis function (RBF), etc.

In some embodiments, the processor selects RBF as the kernel function to effectively handle nonlinear relationships, suitable for complex participation rate evaluation scenarios. Simultaneously, the processor sets the penalty parameter, which is configured to control the complexity and fault tolerance capability of the model. Then, the processor uses the training data to perform preliminary training on the support vector machine. During the training process, an optimal decision boundary is found to maximize the margin between different participation rate categories.

The optimal decision boundary refers to the internal parameters of the constructed participation rate evaluation model. The optimal decision boundary is learned by the machine learning algorithm from historical behavioral data during the model training process. Its function is to ensure that the model can stably and accurately output the quantified evaluation result based on the behavioral data of the research staff.

The test result refers to a quantitative value of accuracy obtained after evaluating the performance of a trained support vector machine using reserved test data.

In some embodiments, after training is completed, the model training module uses the test data to perform the accuracy test on the trained support vector machine to evaluate the generalization capability of the support vector machine, i.e., the prediction performance of the support vector machine on unseen data.

In some embodiments, the test result is used to determine whether the support vector machine achieves an expected performance level. If the test accuracy does not reach a preset target value, the processor may optimize and adjust the parameters of the support vector machine based on the test result. For example, the processor adjusts the kernel parameter (e.g., a y value of RBF) and the penalty parameter based on the test result through methods such as grid search, random search, or Bayesian optimization. After adjusting the kernel parameter and the penalty parameter, the processor re-trains the support vector machine using the new parameters and performs testing again. The above process of training-testing-parameter adjustment is iteratively executed until the test accuracy of the support vector machine reaches the preset target value.

In some embodiments, after training is completed, the processor may use the test data to evaluate the performance of the support vector machine. Evaluation metrics may include accuracy, precision, recall, etc. If the model performance does not meet the preset target value, the processor performs optimization by adjusting hyperparameters or increasing training epochs until the model performance reaches the target value.

In some embodiments, the processor outputs the support vector machine model whose test result reaches the target value as a converged participation rate evaluation model.

Through the model training, the processor constructs a highly optimized and stable participation rate evaluation model, which not only accurately evaluates the participation rate of the research staff in the relay inspection tasks but also adapts to characteristics of different populations and inspection environments.

In S4, the evaluation result output by the participation rate evaluation model is acquired.

In some embodiments, the processor inputs the input features corresponding to each research staff member into the participation rate evaluation model and obtains an evaluation result for each research staff member from the participation rate evaluation model. More descriptions of the input features may be found in S2 and related descriptions.

In S5, the evaluation result is imported into an evaluation database, and a person segmentation level is determined by performing the first clustering on the corresponding research staff in the evaluation database.

The evaluation database (also referred to as an evaluation database of the research staff) refers to a database for storing and managing the evaluation results and other information of the research staff (e.g., personal basic information, inspection history, etc.). The evaluation database may be preset by professional technical personnel based on historical data.

The first clustering refers to a process of dividing the research staff into a plurality of categories with similar characteristics using a clustering algorithm based on the evaluation results of the research staff. The first clustering may include a plurality of algorithms, such as K-means clustering or hierarchical clustering.

The person segmentation level is a level of the research staff divided through the first clustering based on the evaluation results. In some embodiments, the person segmentation level includes at least one of a high participation rate, a medium participation rate, and a low participation rate.

A determination method of the high participation rate, the medium participation rate, and the low participation rate may be set by professional technical personnel according to actual situations. For example, the high participation rate is that the evaluation result of the research staff is greater than or equal to a first threshold. The medium participation rate is that the evaluation result of the research staff is less than the first threshold and greater than or equal to a second threshold. The low participation rate is that the evaluation result of the research staff is less than the second threshold. The first threshold and the second threshold decrease in sequence and may be preset by professional technical personnel.

In some embodiments, the processor imports the evaluation result into a preset evaluation database. After completing the import of the evaluation result, the processor performs an operation of the first clustering operation on all the research staff in the evaluation database. During the first clustering, the processor automatically groups the research staff with similar characteristics into the same category using a clustering algorithm based on the evaluation result of each research staff, to obtain the person segmentation level, thereby facilitating subsequent task assignment and management.

By dividing the person segmentation level corresponding to the research staff, the participation rate degree of the research staff can be intuitively reflected, facilitating subsequent management and motivation, and laying a foundation for further refined management.

In some embodiments, the processor performs further clustering analysis based on other characteristics of the research staff, and related content is described in S6.

In S6, a clustering label is determined by performing a second clustering on the person segmentation level based on the research location, age, household income, and parental education level.

The research location refers to information about a permanent residence or registration location bound to a personal identity of the research staff, which is a static attribute of the research staff. For example, the research location is used to describe a fixed geographical region to which the research staff belongs (e.g., a city or an administrative division), and usually does not change with the location of a single relay inspection task performed by the research staff.

The processor may determine the research location through the registration information of the research staff.

The household income refers to an annual or monthly total income of the family of the research staff. The processor may obtain the household income through a background information questionnaire filled out by the research staff upon employment or participation in a project.

The parental education level refers to the highest education level received by parents of the research staff. The processor may obtain the parental education level through a social background questionnaire or a demographic information collection form.

The second clustering refers to a refined grouping process performed on the research staff within the same level based on the research location, the age, the household income, and the parental education level as features, on the basis of the divided person segmentation level.

In some embodiments, the processor performs the second clustering on the person segmentation level and further considers personal characteristics of the research staff on the basis of the person segmentation level, to achieve more accurate classification and management. The processor performs the second clustering based on the four key features of the research location, the age, the household income, and the parental education level, respectively. The second clustering considers environmental, cultural, and resource differences that may exist in different geographical locations, differences in participation rate that may exist among different age groups, potential associations between family economic status and motivation and capability of the research staff, and possible influences of parental education background on the participation rate of the research staff.

The clustering label refers to an identifier assigned to each research staff member, which comprehensively reflects a participation rate level and personal background characteristics of the research staff.

In some embodiments, through the second clustering, the processor generates a comprehensive and more detailed clustering label for each research staff member. For example, a research staff member may be labeled as: “Grade A-urban-adolescent-medium income-higher education background.” The refined clustering label can more comprehensively describe characteristics of the research staff, provide a more accurate basis for subsequent task assignment and management, and also help improve the participation rate in inspection, and provide more suitable motivation and support measures for the research staff with different characteristics, thereby improving overall inspection effectiveness and research quality.

In some embodiments, a result of the first clustering and the second clustering performed by the processor may be periodically updated to reflect dynamic changes in the participation rate of the research staff. For example, the first clustering and the second clustering are re-performed weekly or monthly to capture a change trend of the participation rate of the research staff. The dynamic update mechanism helps maintain the timeliness and accuracy of the evaluation result.

By performing the first clustering and the second clustering, a structured and hierarchical evaluation database is formed, providing important support for subsequent task assignment and management. This not only helps identify the research staff with a high participation rate, but also helps identify the research staff with a low participation rate who need additional support or incentives, thereby improving overall inspection efficiency and quality.

In S7, a first mapping relationship is constructed based on the person segmentation level and the clustering label, and the first mapping relationship is sent to a management interface of the relay inspection task.

The first mapping relationship refers to an association relationship established between the person segmentation level and the clustering label.

In some embodiments, for each research staff member in the evaluation database, the processor associates the person segmentation level and the clustering label to which the research staff member belongs, thereby forming the first mapping relationship with a research staff ID as a key index.

The management interface for the relay inspection task refers to a software operation platform integrating data visualization and interactive decision-making functions. For example, the management interface is used to graphically display analysis results generated by the system (e.g., the person segmentation level, the clustering label, and the first mapping relationship), and supports management staff in performing multi-dimensional data viewing, condition filtering, and task assignment decisions.

The management interface for the relay inspection task includes a display screen, an interaction terminal, or the like.

In some embodiments, the processor sends the first mapping relationship to the management interface for the relay inspection task through an API call, Bluetooth, WIFI, or the like.

In some embodiments, the processor first obtains an output result of the evaluation import module, including the person segmentation level of the research staff and multi-dimensional clustering labels, and establishes a mapping association (i.e., the first mapping relationship) between the research staff and the person segmentation level, as well as the clustering labels. The processor then presents the first mapping relationship in a visual form on the management interface for the relay inspection task, facilitating management staff to intuitively understand an overall distribution of the research staff.

In some embodiments, the processor builds the first mapping relationship based on the person segmentation level and the clustering label, and sends the first mapping relationship to the management interface for the relay inspection task.

In some embodiments, the processor establishes a mapping association (i.e., the first mapping relationship) between the research staff and the person segmentation level, as well as the clustering labels, thereby associating the person segmentation level and the clustering label with the corresponding research staff. Then, the first mapping relationship is converted into a visual form, such as a chart or an interactive interface, and sent to the management interface for the relay inspection task. The aforementioned visual display enables management staff to intuitively understand the distribution and features of the research staff, providing convenience for subsequent task assignment decisions.

In S8, preset assignment information of the relay inspection task is acquired.

The preset assignment information (also referred to as the preset task assignment information) refers to pre-set parameters related to task assignment for the relay inspection task.

In some embodiments, the preset assignment information includes at least one of a quantity, a type, a difficulty, and a time schedule of the relay inspection task, providing an initial framework for task assignment.

The difficulty refers to a preset difficulty level based on the nature of the relay inspection task.

The time schedule refers to a time plan set for the relay inspection task.

In some embodiments, the preset assignment information is set by professional technical staff based on experience.

In S9, feature information of the relay inspection task is parsed.

The feature information refers to data describing task attributes in the relay inspection task.

In some embodiments, the feature information includes at least one of a regional feature, a difficulty feature, and a support demand feature.

The regional feature refers to a geographic location or regional characteristic involved in the execution of the relay inspection task. For example, the regional feature includes a task execution location.

The task execution location refers to a geographic location where the relay inspection task needs to be actually performed.

The difficulty feature refers to a feature comprehensively measured based on technical complexity and operational proficiency required to complete the relay inspection task. For example, the difficulty feature includes a technical requirement, a time limit, or the like.

The technical requirement refers to a specialized skill or professional knowledge required for the research staff to complete a specific relay inspection task.

The time limit refers to a strict time boundary set for the execution of the relay inspection task.

The support demand feature refers to a feature of external resource support required during execution of the relay inspection task. For example, the support demand feature includes a required resource, an auxiliary staff, a personnel correlation requirement, a personnel quantity requirement, or the like.

The required resource refers to a sum of various physical and non-physical resources invested to successfully complete the relay inspection task. For example, the required resource includes an inspection instrument, a sampling tool, protective equipment, or the like.

The auxiliary staff refers to various support roles that need to be configured to assist the research staff in completing the relay inspection task.

The personnel correlation requirement refers to a standard proposed for matching and complementarity between the research staff in terms of skills, experience, or collaboration history to ensure team collaboration quality and efficiency.

The personnel quantity requirement refers to a set scale of personnel for executing the relay inspection task.

In some embodiments, the feature information further includes a team gain demand feature.

The team gain demand feature refers to a gain requirement for a team brought by completing the relay inspection task.

In some embodiments, the processor performs feature parsing on the relay inspection task. For example, the processor extracts the feature information of each relay inspection task and deconstructs the feature information into the following dimensions: by parsing task location information and converting the task location information into a standard geographic code to determine the regional feature; by analyzing and quantifying skill keywords and time nodes in a description of the relay inspection and referring to a preset difficulty level scale to determine the difficulty feature; by identifying and parsing information such as a resource list and personnel configuration in task attributes to determine a quantitative indicator of the support demand feature; by identifying keywords related to team building and knowledge transfer in a task objective to determine the team gain demand feature. Through the aforementioned operations, conversion from original task information to machine-processable feature information is completed, laying a foundation for subsequent precise matching.

In S10, the research staff having a highest correlation with the relay inspection task is filtered out by performing the correlation analysis on the person segmentation level and the clustering label using the feature information as a first search target.

The first search target refers to an object that the system prioritizes for consideration and matching, i.e., the feature information of the relay inspection task.

The correlation analysis refers to evaluating a matching degree between each research staff and the relay inspection task by comparing and analyzing information such as the person segmentation level and the clustering label. For example, the correlation analysis includes using a cosine similarity method.

In some embodiments, the processor converts the feature information into a first vector, and integrates the person segmentation level and the clustering label together into a second vector. The processor calculates a cosine value of an angle between the first vector and the second vector through the cosine similarity method, where a value closer to 1 indicates a higher correlation analysis.

The first vector refers to a vector formed by numerically converting the feature information of the relay inspection task and arranging the feature information in a preset dimension order. The second vector refers to a vector formed by performing feature encoding and numerical conversion on the person segmentation level and the clustering label, and then integrating and arranging the person segmentation level and the clustering label in the preset dimension order.

In some embodiments, some relay inspection tasks may need to be performed in a specific region, or require the research staff with specific skills to complete. Based on the parsed task characteristics, the processor uses the feature information as the first search target to perform the correlation analysis on the person segmentation level and the clustering label, aiming to identify the research staff most suitable for executing the specific relay inspection task. For example, for a relay inspection task with a high difficulty feature, the research staff with a high participation rate and a strong technical background are prioritized. For a task with a specific regional feature, the research staff from that region are prioritized for matching. Through the correlation analysis, the processor can screen out the research staff most relevant to the relay inspection task, thereby establishing a preliminary correspondence between the relay inspection task and the research staff.

In S11, the research staff in the preset assignment information is adjusted by using the filtered research staff.

In some embodiments, by comparing and integrating screened research staff having a high matching degree with the research staff in the preset assignment information, and calibrating and updating the preset assignment information, the processor generates a final assignment result of the research staff.

By using the screened research staff to adjust the research staff in the preset assignment information, the processor ensures that the final task assignment scheme considers both the preset task requirements and fully utilizes the optimization results based on the evaluation result and the clustering analysis.

Through the refined task assignment process, intelligent and personalized assignment and execution of the relay inspection task can be achieved. This not only improves the efficiency and quality of task execution but also provides appropriate task challenges and support based on the characteristics and performance of the research staff, thereby forming a virtuous cycle within the inspection ecosystem and comprehensively enhancing the participation rate level and effectiveness of the relay inspection task.

In some embodiments, the process 200 may further include S12-S14.

In S12, the execution result of the relay inspection task after adjusting the research staff in the preset assignment information is tracked.

The execution result refers to the actual performance and outcome of the work performed by the research staff according to the assigned task. For example, the execution result includes indicators in a plurality of aspects such as a task completion rate, an inspection quality, and a time efficiency.

In some embodiments, the processor can continuously track the execution result after the inspection task is adjusted. By monitoring the execution result in real time, the processor can promptly grasp the actual status of the relay inspection task execution, thereby providing data support for subsequent evaluation and optimization.

In S13, the research staff in the relay inspection task is evaluated according to the execution result to determine research staff characteristics for which the execution result satisfies an execution requirement.

The execution requirement refers to a standard and condition required for the successful completion of the relay inspection task, for example, including a quality requirement, an efficiency requirement, a technical requirement, or the like. The execution requirement may be set by professional technical personnel.

The research staff characteristics are characteristics of the research staff who satisfy the execution requirement during the execution of the relay inspection task. For example, the research staff characteristics include a skill level, a work attitude, an adaptability, or the like.

In some embodiments, based on the collected execution result, the processor evaluates the research staff participating in the relay inspection task. The evaluation process considers not only the task completion status of the relay inspection task but also analyzes special skills demonstrated by the research staff during execution, problem-solving abilities, team collaboration spirit, and other aspects. Through a comprehensive evaluation, research staff who perform excellently in actual execution and satisfy or exceed the execution requirement are identified, and the research staff characteristics are summarized.

In S14, the research staff characteristics are fed back to the management interface of the relay inspection task, and searching and adjusting of the research staff are re-performed to update the person segmentation level, the clustering label, and the training dataset by using the fed back research staff characteristics as a second search target.

In some embodiments, the processor may automatically push or update the research staff characteristics to a display region of the management interface of the relay inspection task. For example, on an information card of the research staff in the management interface of the relay inspection task, labels such as “excels at emergency tasks” or “high-precision operation” are added, or prompts are provided in forms such as highlighting or pop-ups, enabling an administrator to intuitively obtain the research staff characteristics.

The second search target refers to a search basis used for re-searching and optimizing the adjustment of the research staff after the first round of the research staff adjustment and assignment. Unlike the first search target, which is based on the needs of the task itself in the first round, the second search target is a search basis for optimizing subsequent research staff assignments and is driven by feedback from the actual relay inspection task. That is, the feedback on the research staff characteristics is used as the second search target.

In some embodiments, using the research staff characteristics formed based on the feedback as the second search target, the processor performs a new round of retrieval and matching among the research staff to identify research staff possessing similar research staff characteristics. The research staff obtained from the new round of retrieval and matching, and their complete data constitute a basis for system update. For example, the processor feeds the research staff identified in the new round back to the evaluation import module and executes the first clustering and the second clustering again to update the person segmentation level and the clustering label, making them more accurately reflect the actual capability state of the research staff. Furthermore, the behavioral data corresponding to the research staff after the new round of retrieval and matching is used as new samples and fed back to the model training module to expand and update the training dataset of the participation rate evaluation model, thereby continuously improving the accuracy and predictive capability of the participation rate evaluation model.

Through continuous tracking, evaluation, and optimization, the system can continuously learn and adapt to changes in the actual inspection environment, improving the precision and effectiveness of task assignment and significantly enhancing the participation rate level of the research staff.

By collecting multi-dimensional behavioral data, the processor provides comprehensive data support for an objective evaluation of the participation rate level. The processor preprocesses the behavioral data, constructs the training dataset, and segments the training dataset to determine the training data and the test data. By constructing and segmenting the training dataset, preparation is made for subsequent machine learning model training, ensuring the effectiveness of the model training. Based on a machine learning algorithm, the processor constructs a machine learning model capable of objectively and quantitatively evaluating an evaluation result of the research staff through iterative learning using the training data and the test data. By obtaining the evaluation result output by the participation rate evaluation model, importing it into the evaluation database, and performing the first clustering and the second clustering, the processor achieves effective organization and management of the evaluation result, providing a data foundation for subsequent task assignment. By performing the correlation analysis according to the person segmentation level and the clustering label, and adjusting the research staff in the preset assignment information, the processor can assign tasks based on the actual performance and capability of the research staff, thereby improving the overall inspection efficiency and quality.

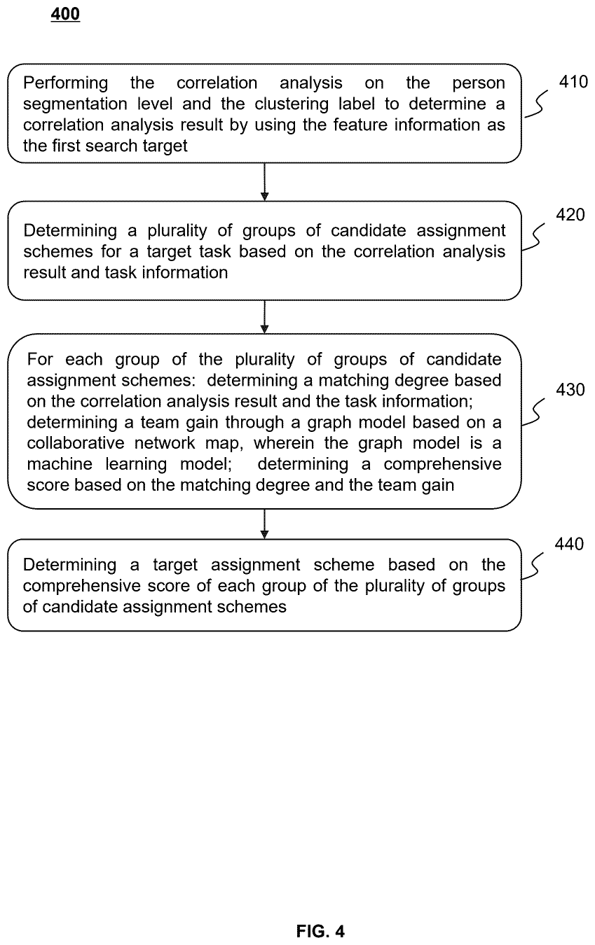

FIG. 4 is a flowchart illustrating an exemplary process for determining a target assignment scheme according to some embodiments of the present disclosure.

As shown in FIG. 4, a process 400 includes steps 410-440, which is executed by the processor.

In step 410, the correlation analysis is performed on the person segmentation level and the clustering label to determine a correlation analysis result by using the feature information as the first search target.

More descriptions of the feature information, the first search target, the person segmentation level, the clustering label, and how to perform the correlation analysis may be found in FIG. 2 and related descriptions.

The correlation analysis result refers to the degree of correlation between the research staff and the relay inspection task. For example, the correlation analysis result may be characterized by a value between 0 and 1. The closer the correlation analysis result is to 1, the higher the degree of correlation between the research staff and the relay inspection task.

In some embodiments, using the feature information as the first search target, the processor may determine the correlation analysis result by performing the correlation analysis on the person segmentation level and the clustering label in various ways. For example, based on each type of feature information (e.g., the regional feature, the difficulty feature, or the support demand feature), the person segmentation level, and the clustering label, the processor may determine a correlation analysis sub-result for each type of feature information by querying a correlation relationship table, and then perform a weighted summation on all the correlation analysis sub-results with preset weights to determine the correlation analysis result. The correlation relationship table may include a relationship among each type of feature information, the person segmentation level, the clustering label, and the correlation analysis sub-result. The correlation relationship table may be determined based on historical data.

The correlation analysis sub-result is the degree of correlation between the research staff and the relay inspection task for each type of feature information.

In step 420, a plurality of groups of candidate assignment schemes for a target task are determined based on the correlation analysis result and task information.

More descriptions of the task information may be found in FIG. 2 and related descriptions.

The target task refers to a specific relay inspection task that currently requires personnel assignment.

Unlike a global assignment that simultaneously considers a plurality of tasks, the present embodiment plans an optimal personnel combination for a single target task without considering its impact on resource occupation for other tasks. By simplifying decision logic, the present disclosure aims to efficiently achieve an optimal personnel configuration scheme for the current target task.

In some embodiments, the target task may be set by professional technical personnel according to actual requirements.

The candidate assignment scheme refers to a plurality of different personnel combination schemes planned for completing the target task.

In some embodiments, the processor may determine assignment schemes for the relay inspection task that meet the personnel quantity requirement in the task information and where a sum of correlation analysis results of all research staff satisfies a preset threshold condition as the candidate assignment schemes for the target task. Satisfying the preset threshold condition refers to the sum of correlation analysis results of all research staff in the relay inspection task being greater than or equal to the product of the personnel quantity requirement and the personnel correlation requirement.

For example, if a relay inspection task has a personnel quantity requirement of 4 and a personnel correlation requirement of 0.7, then the sum of correlation analysis results of all research staff in the relay inspection task needs to be greater than or equal to 2.8. Merely by way of example, the candidate assignment scheme may include research staff A with a correlation analysis result of 1, research staff B with a correlation analysis result of 0.5, research staff C with a correlation analysis result of 0.4, and research staff D with a correlation analysis result of 0.9.

In step 430, for each group of the plurality of groups of candidate assignment schemes, a matching degree is determined based on the correlation analysis result and the task information; a team gain through a graph model is determined based on a collaborative network map, wherein the graph model is a machine learning model; and a comprehensive score is determined based on the matching degree and the team gain.

The matching degree is a quantitative indicator configured to measure the degree of fit between the candidate assignment scheme and the requirements of the target task. A higher value indicates that the candidate assignment scheme better matches the target task in terms of personnel capability, resource requirements, etc.

In some embodiments, the processor may determine the matching degree in various ways based on the correlation analysis result and the task information. For example, the processor can determine the matching degree by querying a matching degree relationship table based on the correlation analysis result and the task information. The matching degree relationship table may include relationships among the correlation analysis result, the task information, and the matching degree. The matching degree relationship table may be determined based on historical data.

In some embodiments, the processor may also determine the matching degree for each candidate assignment scheme based on a positive correlation relationship between the matching degree and the quotient of the sum of all elements in a first correlation sequence and the sum of all elements in a second correlation sequence, and a positive correlation relationship between the matching degree and the similarity between the first correlation sequence and the second correlation sequence. Exemplary relationships include:

$$p = \frac{{sum}_{A}}{{sum}_{B}} \times sim ( A , B ) , \qquad ( 1 )$$

where p denotes the matching degree of each candidate assignment scheme. sum_{A} denotes the sum of all elements in the first correlation sequence. sum_{B} denotes the sum of all elements in the second correlation sequence. sim(A,B) denotes the similarity between the first correlation sequence and the second correlation sequence, which may be characterized by cosine similarity.

The first correlation sequence is configured to characterize the correlation analysis results of all the research staff in the candidate assignment scheme. Each element in the first correlation sequence has a value equal to the correlation analysis result of each research staff, and its length is determined by the personnel quantity requirement of the relay inspection task.

The second correlation sequence is configured to characterize the personnel correlation requirement that the candidate assignment scheme needs to achieve. Each element in the second correlation sequence has a value equal to the personnel correlation requirement, and its length is determined by the personnel quantity requirement of the relay inspection task.

Merely by way of example, if a relay inspection task has a personnel quantity requirement of 4 and a personnel correlation requirement of 0.7, and a candidate assignment scheme for the relay inspection task includes: research staff A with a correlation analysis result of 1, research staff B with a correlation analysis result of 0.5, research staff C with a correlation analysis result of 0.4, and research staff D with a correlation analysis result of 0.9. Then the first correlation sequence may be characterized by {1, 0.5, 0.4, 0.9}, and the second correlation sequence may be characterized by {0.7, 0.7, 0.7, 0.7}.

In some embodiments, the processor is further configured to determine the matching degree through a prediction model based on the task information, the person segmentation level, the clustering label, and a four-quadrant state. The prediction model is a machine learning model.

The four-quadrant state refers to placing each research staff in a two-dimensional state space composed of growth potential and fatigue risk, and determining the quadrant to which they belong based on the behavioral data. More descriptions of the behavioral data may be found in FIG. 2 and related descriptions.

The growth potential refers to a metric configured to determine whether the research staff continuously exhibits positive capability development trends. The growth potential is a binary state indicator, including positive and negative states. When growth potential is positive, it indicates that the research staff has the potential for continuous learning and undertaking higher difficulty tasks, and is on a benign development track; conversely, it indicates that their capability development has stagnated or declined, requiring attention to their training or support needs.

In some embodiments, the processor may determine the growth potential as positive when learning speed, task difficulty escalation, and task completion status all meet preset qualified thresholds; otherwise, it is determined to be negative

The learning speed refers to the rate at which the capability level of the research staff increases with experience in the relay inspection tasks. The task difficulty escalation refers to the increase in difficulty level of the relay inspection tasks completed by the research staff.

The fatigue risk refers to a metric configured to warn whether the research staff face state decline risks due to excessive workload. The fatigue risk is a binary state indicator, including positive and negative states. When fatigue risk is positive, it indicates that the research staff currently has a moderate workload and stable state, with controllable fatigue risk; conversely, it indicates that they face high work pressure and state decline risk, requiring timely adjustment of their task load to prevent performance decline or error rate increase.

In some embodiments, when a task density is higher than a preset density threshold and an abnormal report rate is higher than a preset abnormal threshold, fatigue risk is negative; otherwise, it is positive.

The task density refers to a count of relay inspection tasks assigned to the research staff per unit time (e.g., weekly or monthly), which is configured to measure the concentration degree of their workload.

In some embodiments, the processor determines the four-quadrant state by orthogonally combining the growth potential and the fatigue risk to construct a two-dimensional state space. The assignment rules for the two-dimensional state space are set by professional technical personnel.

For example, using the growth potential as the vertical axis and the fatigue risk as the horizontal axis: when the growth potential is positive and the fatigue risk is positive, the four-quadrant state is the first quadrant; when the growth potential is positive and the fatigue risk is negative, the four-quadrant state is the second quadrant; when the growth potential is negative and the fatigue risk is negative, the four-quadrant state is the third quadrant; when the growth potential is negative and the fatigue risk is positive, the four-quadrant state is the fourth quadrant.

As another example, using the fatigue risk as the vertical axis and the growth potential as the horizontal axis: when the fatigue risk is positive and the growth potential is positive, the four-quadrant state is the first quadrant; when the fatigue risk is positive and the growth potential is negative, the four-quadrant state is the second quadrant; when the fatigue risk is negative and the growth potential is negative, the four-quadrant state is the third quadrant; when the fatigue risk is negative and the growth potential is positive, the four-quadrant state is the fourth quadrant.

The prediction model refers to a model configured to determine the matching degree. For example, the prediction model includes a neural network (NN) model, a deep neural network (DNN) model, etc.

In some embodiments, inputs to the prediction model include the task information, the person segmentation level, the clustering label, and the four-quadrant state. Outputs of the prediction model include the matching degree.

In some embodiments, the prediction model is obtained by training based on a large count of first training samples with first labels. By inputting a plurality of first training samples with first labels into an initial prediction model, a value of a loss function is determined based on the first labels and a result of the initial prediction model, and the initial prediction model is iteratively updated based on the value of the loss function. When a preset condition is satisfied, the model training is completed, and a trained prediction model is obtained. The preset condition includes the loss function converging, an iteration count reaching a threshold, etc.

In some embodiments, the first training samples for training the prediction model include sample task information, sample person segmentation levels, sample clustering labels, and sample four-quadrant states in historical sample data. The first label is an actual matching degree. The actual matching degree is determined based on historical task completion status, where a better historical task completion status corresponds to a higher matching degree. The historical task completion status is determined by scoring from professional technical personnel.

Based on the task information, the person segmentation level, and the clustering label, and further combined with the four-quadrant state, the matching degree is determined via the prediction model. This avoids the limitation of relying solely on static feature evaluation, making subsequent task assignment more forward-looking.

The collaborative network map is a knowledge graph configured to represent collaborative relationships and collaboration effects among the research staff.

The collaborative network map includes a plurality of nodes and edges, where the nodes and the edges have attributes.

The nodes include research staff in each group of candidate assignment schemes. Attributes of a node reflect characteristics of the node. For example, the attributes of the node include basic information of the research staff (e.g., age, job rank), professional background, capabilities in various dimensions (e.g., technical level, work efficiency), results of correlation analysis with a target task, the person segmentation level, the clustering label, etc.

The edge is an element configured to describe whether a collaborative relationship exists between the research staff corresponding to the nodes. That is, an edge exists between two nodes where a collaborative relationship exists. Attributes of the edge include a collaboration count and a collaboration effect between the research staff corresponding to the two connected nodes.

The collaboration count refers to a count of times the two researchers have jointly participated in the same relay inspection task. The processor determines the collaboration count based on the historical data. For example, a count of tasks where the two researchers appear simultaneously in the same historical task personnel list is counted.

The collaboration effect is used to measure the quality and efficiency of the two researchers in jointly completing the relay inspection task in historical collaborations. The processor determines the collaboration effect based on a relationship where the collaboration effect is positively correlated with the task completion status and negatively correlated with the abnormal report rate.

The processor constructs the collaborative network map based on the nodes, the edges, the attributes of the nodes, and the attributes of the edges.

The team gain refers to an additional value generated by a specific combination of the research staff in executing the relay inspection task. For example, the team gain includes a knowledge transfer gain, a collaborative network strengthening gain, an innovation stimulation gain, etc.

The knowledge transfer gain is configured to measure a value of senior research staff transferring knowledge to junior research staff.

In some embodiments, the processor characterizes the knowledge transfer gain using a capability growth situation of the junior research staff. In some embodiments, the processor determines the capability growth situation by comparing the behavioral data of the research staff completing the current relay inspection task with the behavioral data from historical similar relay inspection tasks. For example, under the same inspection scale (e.g., the same count of inspected persons), a reduction in the inspection duration is used to quantify the growth situation of the research staff.

The junior research staff refers to research staff whose correlation analysis result is below a preset analysis threshold.

The collaborative network strengthening gain is configured to measure a value generated by the research staff on the balance of the collaborative network map.

In some embodiments, the processor determines the collaborative network strengthening gain by weighting a first score, a second score, and a third score with preset weights, based on a relationship where the collaborative network strengthening gain is positively correlated with the first score, the second score, and the third score.

The first score is configured to quantify a value of forming a weak-tie team.

In some embodiments, the processor filters out research staff belonging to weak-tie combinations, i.e., research staff whose historical collaboration count is less than or equal to a preset low-frequency collaboration threshold (if no collaborative relationship exists, the collaboration count is recorded as 0). Subsequently, in response to a sum of collaboration counts of all weak-tie combinations not being 0, the processor uses a reciprocal of the sum as the first score; in response to the sum of collaboration counts of all weak-tie combinations being 0, the first score is preset by professional technical personnel.

The second score is configured to quantify a value of core team capability.

In some embodiments, the processor filters out combinations of a plurality of research staff whose collaboration count is greater than a preset high-frequency collaboration threshold, determines a difference between a difficulty of the current relay inspection task and an average difficulty of previously executed relay inspection tasks for each combination, and finally sums portions of all differences that are greater than zero, using the total sum as the second score.

The third score is configured to quantify a value of reducing dependence on high-frequency research staff.

In some embodiments, the processor first identifies all members who are the high-frequency research staff. Subsequently, a reciprocal of a count of these members is configured as the third score.

The high-frequency research staff refers to research staff whose total count of participations in historical tasks in the collaborative network map exceeds a preset count threshold.

The innovation stimulation gain is configured to measure an innovation degree of the research outcome. The innovation stimulation gain is typically determined by experts' scoring based on the task completion result. For example, if participating research staff discovers a potential association between pneumonia infection and a certain regional habit based on the inspection result, such an innovative outcome would receive a corresponding innovation stimulation gain.

In some embodiments, the processor sums the knowledge transfer gain, the collaborative network strengthening gain, and the innovation stimulation gain as the team gain.

In some embodiments, the processor determines the team gain via a graph model based on the collaborative network map. The graph model is a machine learning model.

The graph model includes a graph neural network (GNN) model.

In some embodiments, the graph model is obtained by training based on a large count of second training samples with second labels. A training process of the graph model is similar to the training process of the prediction model, and details are not repeated herein.

The second training samples for training the graph model are sample collaborative network maps in historical sample data. The second label corresponds to an actual team gain of the sample collaborative network map. The actual team gain is the sum of the knowledge transfer gain, the collaboration network enhancement gain, and the innovation stimulation gain.

The comprehensive score is an overall evaluation score for the candidate assignment scheme and is configured for ranking and selecting among different candidate assignment schemes.

In some embodiments, the processor may determine the comprehensive score based on the matching degree and the team gain in various manners. For example, the processor determines the comprehensive score based on the matching degree and the team gain through a weighted summation.

In some embodiments, the processor determines weights for the weighted summation by querying a weight relationship table based on the task information. The weight relationship table may include a relationship between the task information and the weights. The weight relationship table may be constructed based on human experience.

In step 440, a target assignment scheme is determined based on the comprehensive score of each group of the plurality of groups of candidate assignment schemes.

The target assignment scheme refers to a personnel assignment scheme used for the actual execution of a target task.

In some embodiments, the processor may sort all the candidate assignment schemes in descending order of their comprehensive scores and select the scheme with the highest comprehensive score as the target assignment scheme. If the plurality of the candidate assignment schemes have the same comprehensive score, a professional technician determines the final scheme based on actual requirements.

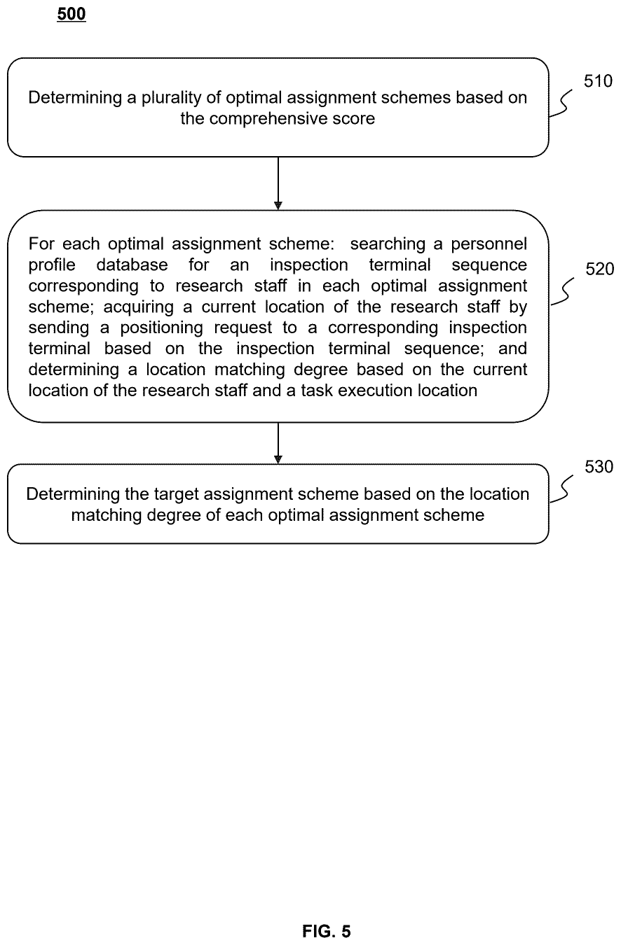

More descriptions of the target assignment scheme may be found in FIG. 5 and related descriptions.

By generating the plurality of groups of candidate assignment schemes and evaluating the matching degree of each scheme in relation to both the matching degree and team gain, the adaptability of research staff assignment is ensured, manual matching errors are reduced, and the execution efficiency and participation rate level of the relay inspection task (e.g., Mycoplasma pneumoniae detection task) are improved. Simultaneously, by introducing the team gain evaluation, the traditional assignment pattern is broken, providing the research staff with diversified practical opportunities (e.g., experienced staff guiding new staff), which facilitates knowledge transfer and optimization of the collaborative network map, thereby helping to enhance the overall capability of the team.

FIG. 5 is a flowchart illustrating an exemplary process 500 for determining a target assignment scheme according to other embodiments of the present disclosure.

As shown in FIG. 5, the process 500 includes steps 510-530, and is executed by the processor.

In step 510, a plurality of optimal assignment schemes are determined based on the comprehensive score.

More descriptions of the comprehensive score may be found in FIG. 4 and related descriptions.

The optimal assignment scheme refers to an assignment scheme selected from all the candidate assignment schemes that ranks high.

In some embodiments, the processor may use the top N candidate assignment schemes ranked by the comprehensive score as the optimal assignment schemes. N may be set by a professional technician.

In step 520, for each optimal assignment scheme: a personnel profile database is searched for an inspection terminal sequence corresponding to research staff in each optimal assignment scheme; a current location of the research staff is acquired by sending a positioning request to a corresponding inspection terminal based on the inspection terminal sequence; and a location matching degree is determined based on the current location of the research staff and a task execution location.

The personnel profile database is a database storing information related to all the research staff. For example, the personnel profile database may include relevant information of all the research staff, such as names, ID numbers, contact information, and the corresponding inspection terminal sequences.

The inspection terminal refers to a mobile data terminal configured for executing the relay inspection task, which is equipped with a medical-grade data acquisition module and a communication module, capable of transmitting collected data and status information of the terminal itself (e.g., battery level, location) to a remote server (e.g., a processor integrated in the processor, etc.).

The inspection terminal is suitable for high-frequency, multi-scenario mobile operations in medical inspections, and each research staff member is equipped with one inspection terminal.

The inspection terminal sequence refers to a unique identification code of the inspection terminal, and is configured for identifying an independent device (e.g., the inspection terminal) in a mobile network.

In some embodiments, the processor may query the personnel profile database based on identity information of the research staff in the optimal assignment scheme to retrieve and obtain the inspection terminal sequence bound thereto.

The positioning request refers to an instruction sent by the processor to the inspection terminal for obtaining the current geographical location information thereof. The positioning request is a basic communication function, typically based on GPS, base station, or Wi-Fi positioning technology.

In some embodiments, the processor sends the positioning request to the inspection terminal corresponding to each research staff in the optimal assignment scheme via a wireless communication network.

The current location refers to a geographical location reported in real time by the inspection terminal. Since each research staff member is equipped with one inspection terminal, the location of the inspection terminal is considered the current location of the research staff. For example, after receiving the positioning request, the inspection terminal activates a positioning module to obtain latitude and longitude coordinates and transmits the coordinate data back to the processor via a communication module.

The location matching degree is a quantitative indicator configured to measure the overall proximity degree between the current location of the research staff in the optimal assignment scheme and the task execution location. More descriptions of the task execution location may be found in FIG. 2 and related descriptions.

In some embodiments, the processor may also determine the location matching degree of each optimal assignment scheme based on a negative correlation between the location matching degree and an average distance between the current location of each research staff and the task execution location, and a negative correlation between the location matching degree and a variance of distances between the current location of each research staff and the task execution location. Exemplary relationships include:

$$S = \frac{K}{L \times A} , \qquad ( 2 )$$

where s denotes the location matching degree of each optimal assignment scheme. K denotes a preset coefficient, which may be set manually. L denotes an average distance between the current location of each research staff and the task execution location in the current optimal assignment scheme. A denotes a variance of distances between the current location of each research staff and the task execution location in the current optimal assignment scheme. If there is only one research staff in the current optimal assignment scheme, A is preset by a professional technician.

In step 530, the target assignment scheme is determined based on the location matching degree of each optimal assignment scheme.

In some embodiments, the processor uses the optimal assignment scheme with the highest location matching degree as the target assignment scheme.

The processor filters out the plurality of optimal assignment schemes based on the comprehensive score, providing an optimized selection range for final decision-making. Subsequently, by querying the personnel profile database to obtain the inspection terminal sequence and initiating a positioning request to the inspection terminal, the current location of the research staff is obtained. Furthermore, in combination with the task execution location, the location matching degree of each optimal assignment scheme is assessed, and the optimal assignment scheme with the highest location matching degree is selected as the target assignment scheme. This not only significantly reduces the commuting distance and travel time of the research staff, facilitating the efficient completion of the relay inspection task, but also ensures that behavioral data, such as the recorded inspection duration, more accurately reflects the actual operation time, providing more reliable data support for the participation rate evaluation.

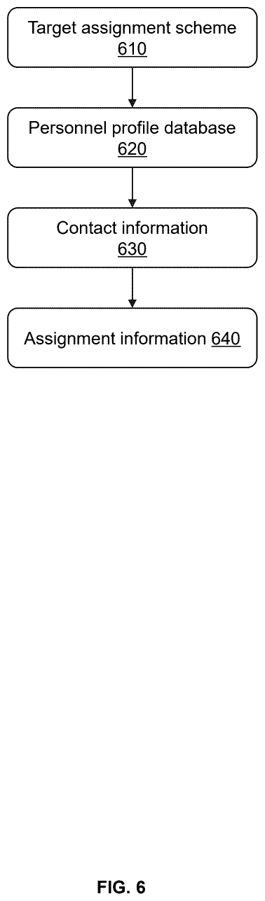

FIG. 6 is a schematic diagram illustrating a process for sending assignment information according to some embodiments of the present disclosure.

In some embodiments, as shown in FIG. 6, the processor searches a personnel profile database 620 for contact information 630 of an assigned person based on a target assignment scheme 610. The assigned person refers to the research staff corresponding to the target assignment scheme. The processor sends assignment information 640 to the assigned person based on the contact information 630 of the assigned person. More descriptions of the target assignment scheme and the personnel profile database may be found in FIGS. 4-5 and related descriptions.

In some embodiments, the assigned person refers to the research staff corresponding to the target assignment scheme.

The contact information refers to communication information of the research staff, such as a phone number, an email address, etc.

In some embodiments, the processor uses the research staff corresponding to the target assignment scheme as a query condition, initiates a query request to the personnel profile database, and retrieves and obtains the contact information corresponding to each assigned person, thereby providing a necessary information channel for subsequent task issuance and communication.

The assignment information refers to information regarding participation in the relay inspection task that is conveyed by the processor to the research staff based on the target assignment scheme. Merely by way of example, the assignment information includes task information, a location of the target inspection vehicle, etc.

More descriptions of the task information may be found in FIG. 2 and related descriptions.

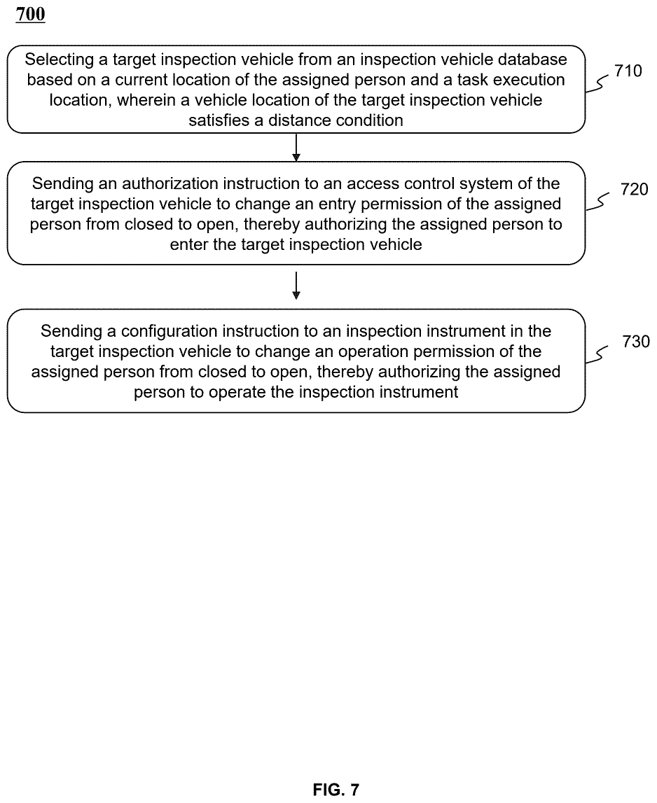

The location of the target inspection vehicle refers to a geographic location where the target inspection vehicle is located. More descriptions of the target inspection vehicle may be found in FIG. 7 and related descriptions.

In some embodiments, the processor, based on the contact information of the assigned personnel, automatically sends task assignment information to each assigned person directionally through an integrated SMS gateway, email server, or API interface.

The processor searches for the contact information based on the target assignment scheme and sends the assignment information to the assigned personnel, effectively avoiding delays, omissions, or errors that may occur in manual information transmission, and improving the efficiency and reliability of task distribution.

FIG. 7 is a flowchart illustrating an exemplary process for entering a target inspection vehicle and operating an inspection instrument according to some embodiments of the present disclosure.

As shown in FIG. 7, a process 700 includes steps 710-730, and is executed by the processor.

In step 710, a target inspection vehicle is selected from an inspection vehicle database based on a current location of the assigned person and a task execution location. A vehicle location of the target inspection vehicle satisfies a distance condition.

More descriptions of the task execution location may be found in FIG. 2 and related descriptions. More descriptions of the current location may be found in FIG. 5 and related descriptions.

The vehicle location refers to a geographic location obtained by the inspection vehicle through an onboard GPS. The onboard GPS can communicate with the processor.

The inspection vehicle database refers to a database storing information about all inspection vehicles. In some embodiments, the inspection vehicle database may include a vehicle number, the vehicle location, an occupancy status, etc., of the inspection vehicle.

The inspection vehicle database is constructed based on historical data.

The target inspection vehicle refers to an inspection vehicle selected from the inspection vehicle database for performing an inspection task.

In some embodiments, the target inspection vehicle integrates devices such as a dedicated inspection instrument and a data processing unit. On the basis of having conventional driving functions, it can also achieve mobile and on-site data collection and experimental analysis through various types of inspection instruments it carries. The interior of the target inspection vehicle can be modularly arranged according to actual inspection needs, dividing functional areas such as an experimental operation area, a sample storage area, a data processing area, and a power supply area for equipment, to ensure stable operation of the inspection instruments in mobile or complex environments.

In some embodiments, the processor, based on the current location of the assigned personnel and the task execution location, constructs a corresponding minimum enclosing circle. Then, the vehicle locations of all inspection vehicles within a minimum inscribed circle are obtained from the inspection vehicle database. Finally, a mobile inspection vehicle within the minimum enclosing circle, whose vehicle location satisfies the distance condition, is determined as the target inspection vehicle.

The distance condition may be set according to actual needs. Merely by way of example, the distance condition includes that a sum of distances from the vehicle location to the task execution location and to the assigned person is minimized.

In step 720, an authorization instruction is sent to an access control system of the target inspection vehicle to change an entry permission of the assigned person from closed to open, thereby authorizing the assigned person to enter the target inspection vehicle.

The access control system refers to an electronic security control system installed in the target inspection vehicle for controlling the opening and closing of a vehicle door lock. For example, it includes a central controller, an electronic door lock, an identity recognition module (e.g., a card reader, a fingerprint recognizer), and a communication unit.

The authorization instruction refers to a permission credential configured to grant the assigned person permission to enter the inspection vehicle. For example, it includes an identity identifier of the assigned person (e.g., an employee ID or a virtual access card number) and an authorization time window.

The authorization time window refers to a time period during which the assigned persons are permitted to enter the target inspection vehicle. The authorization time window specifies an effective start time and an expiration end time of the entry permission. Once the authorization time window is exceeded, the entry permission is automatically revoked.

In some embodiments, the processor sends the authorization instruction encrypted to the access control system of the target inspection vehicle via a cellular network or a dedicated Internet of Things. After receiving the authorization instruction, the access control system adds the identity identifier of the assigned person to a temporary whitelist within the authorization time window, enabling them to obtain the entry permission, thereby allowing entry into the target inspection vehicle.

In step 730, a configuration instruction is sent to an inspection instrument in the target inspection vehicle to change an operation permission of the assigned person from closed to open, thereby authorizing the assigned person to operate the inspection instrument.

The inspection instrument refers to equipment or tools deployed within the target inspection vehicle for performing tasks, for example, a sensor, an analyzer, a biosafety cabinet, etc.

The configuration instruction refers to a permission credential used to grant the assigned person access to the inspection instrument on the inspection vehicle. For example, it includes the identity identifier of the assigned person and an authorized operation level.

In some embodiments, the processor sends the configuration instruction to a gateway within the target inspection vehicle via a secure communication link. After receiving the configuration instruction, the gateway distributes it to a designated inspection instrument. A control unit within the inspection instrument accordingly updates its user permission list, changing the operation permission of the designated assigned person from closed to open, thereby precisely enabling login and usage permissions of the assigned person on the inspection instrument.

The processor selects the target inspection vehicle based on the current location of the assigned person and the task execution location, ensuring efficient utilization of nearby resources. Subsequently, by sending the authorization instruction to the access control system and opening the entry permission of the assigned person, flexibility and security of access control are ensured. Finally, a configuration instruction is sent through the inspection instrument to grant the operation permission to the assigned person, ensuring execution safety.

Any step of the method described above may be stored as computer instructions or programs in a non-restricted computer memory and can be invoked and recognized by a non-restricted computer processor to implement any method in the embodiments of the present disclosure, without unnecessary limitations.

Obviously, those skilled in the art may make various modifications and variations to the present disclosure without departing from the scope of the present disclosure. Thus, if these modifications and variations of the present disclosure fall within the scope of the present disclosure and its equivalent technologies, the present disclosure is intended to include these modifications and variations.

What is claimed is:

1. An evaluation system for enhancing a participation rate of Mycoplasma pneumoniae detection through relay inspection, comprising:
a data collection module, configured to collect behavioral data of research staff, wherein the behavioral data includes at least one of an inspection duration, an inspection frequency, a task completion status, and an abnormal report rate;
a data preprocessing module, configured to perform preprocessing on the behavioral data, construct a training dataset, and segment the training dataset to determine training data and test data;
a model training module, configured to generate a participation rate evaluation model by performing model training and model testing using the training data and the test data based on a machine learning algorithm, wherein the participation rate evaluation model is configured to determine an evaluation result based on the behavioral data;
an evaluation import module, configured to:
acquire the evaluation result output by the participation rate evaluation model;
import the evaluation result into an evaluation database, and determine a person segmentation level by performing first clustering on corresponding research staff in the evaluation database, wherein the person segmentation level includes at least one of a high participation rate, a medium participation rate, and a low participation rate; and
determine a clustering label by performing second clustering on the person segmentation level based on a research location, age, a household income, and a parental education level; and
a task assignment module, configured to:
construct a first mapping relationship based on the person segmentation level and the clustering label, and send the first mapping relationship to a management interface of a relay inspection task;
obtain preset assignment information of the relay inspection task, wherein the preset assignment information includes at least one of a quantity, a type, a difficulty, and a time schedule of the relay inspection task;
parse feature information of the relay inspection task, wherein the feature information includes at least one of a regional feature, a difficulty feature, and a support demand feature;
filter out research staff having a highest correlation with the relay inspection task by performing correlation analysis on the person segmentation level and the clustering label using the feature information as a first search target; and
adjust research staff in the preset assignment information by using the filtered research staff.

2. The system of claim 1, wherein the data preprocessing module is further configured to:
perform missing value processing and outlier processing on the behavioral data, and perform data format normalization on the behavioral data from different sources to complete the preprocessing of the behavioral data;
establish a second mapping relationship between the evaluation result and the inspection duration, as well as the inspection frequency, the task completion status, and the abnormal report rate based on the preprocessed behavioral data; and
construct the training dataset based on the second mapping relationship.

3. The system of claim 2, wherein the data preprocessing module is further configured to:
fill missing values in the behavioral data based on a mode value corresponding to the behavioral data to complete the missing value processing;
delete outliers in the behavioral data after the missing value processing to complete the outlier processing;
perform continuity analysis on the behavioral data after the outlier processing; and
in response to the behavioral data after the continuity analysis having a missing value, complete the missing value processing based on the mode value corresponding to the behavioral data.

4. The system of claim 2, wherein the model training module is further configured to:
construct a support vector machine, select a kernel function and a kernel parameter, set a penalty parameter, and train the support vector machine using the training data to obtain a trained support vector machine;
perform an accuracy test on the trained support vector machine using the test data to determine a test result; and
adjust the kernel parameter and the penalty parameter according to the test result, iteratively train the trained support vector machine until the test result reaches a target value to obtain the participation rate evaluation model.

5. The system of claim 1, wherein the task assignment module is further configured to:
track an execution result of the relay inspection task after adjusting the research staff in the preset assignment information;
evaluate the research staff in the relay inspection task according to the execution result to determine research staff characteristics for which the execution result satisfies an execution requirement; and
feed back the research staff characteristics to the management interface of the relay inspection task, and re-perform searching and adjusting of research staff to update the person segmentation level, the clustering label, and the training dataset by using the fed back research staff characteristics as a second search target.

6. The system of claim 1, wherein the task assignment module is further configured to:
perform the correlation analysis on the person segmentation level and the clustering label to determine a correlation analysis result by using the feature information as the first search target;
determine a plurality of groups of candidate assignment schemes for a target task based on the correlation analysis result and task information;
for each group of the plurality of groups of candidate assignment schemes:
determine a matching degree based on the correlation analysis result and the task information;
determine a team gain through a graph model based on a collaborative network map, wherein the graph model is a machine learning model;
determine a comprehensive score based on the matching degree and the team gain; and
determine a target assignment scheme based on the comprehensive score of each group of the plurality of groups of candidate assignment schemes.

7. The system of claim 6, wherein the task assignment module is further configured to:
determine the matching degree through a prediction model based on the task information, the person segmentation level, the clustering label, and a four-quadrant state, wherein the prediction model is a machine learning model.

8. The system of claim 6, wherein the task assignment module is further configured to:
determine a plurality of optimal assignment schemes based on the comprehensive score;
for each optimal assignment scheme:
search a personnel profile database for an inspection terminal sequence corresponding to research staff in each optimal assignment scheme;
send a positioning request to a corresponding inspection terminal based on the inspection terminal sequence to obtain a current location of the research staff;
determine a location matching degree based on the current location of the research staff and a task execution location; and
determine the target assignment scheme based on the location matching degree of each optimal assignment scheme.

9. The system of claim 1, wherein the task assignment module is further configured to:
search a personnel profile database for contact information of an assigned person based on a target assignment scheme, wherein the assigned person refers to research staff corresponding to the target assignment scheme; and
send assignment information to the assigned person based on the contact information of the assigned person.

10. The system of claim 9, wherein the task assignment module is further configured to:
select a target inspection vehicle from an inspection vehicle database based on a current location of the assigned person and a task execution location, wherein a vehicle location of the target inspection vehicle satisfies a distance condition;
send an authorization instruction to an access control system of the target inspection vehicle to change an entry permission of the assigned person from closed to open, thereby authorizing the assigned person to enter the target inspection vehicle; and
send a configuration instruction to an inspection instrument in the target inspection vehicle to change an operation permission of the assigned person from closed to open, thereby authorizing the assigned person to operate the inspection instrument.

11. An evaluation method for enhancing a participation rate of Mycoplasma pneumoniae detection through relay inspection, executed by an evaluation system for enhancing the participation rate of Mycoplasma pneumoniae detection through relay inspection, comprising:
collecting behavioral data of research staff, wherein the behavioral data includes at least one of an inspection duration, an inspection frequency, a task completion status, and an abnormal report rate;
performing preprocessing on the behavioral data, constructing a training dataset, and segmenting the training dataset to determine training data and test data;
generating a participation rate evaluation model by performing model training and model testing using the training data and the test data based on a machine learning algorithm, wherein the participation rate evaluation model is configured to determine an evaluation result based on the behavioral data;
acquiring the evaluation result output by the participation rate evaluation model;
importing the evaluation result into an evaluation database, and determining a person segmentation level by performing first clustering on corresponding research staff in the evaluation database, wherein the person segmentation level includes at least one of a high participation rate, a medium participation rate, and a low participation rate;
determining a clustering label by performing second clustering on the person segmentation level based on a research location, age, a household income, and a parental education level;
constructing a first mapping relationship based on the person segmentation level and the clustering label, and sending the first mapping relationship to a management interface of a relay inspection task;
acquiring preset assignment information of the relay inspection task, wherein the preset assignment information includes at least one of a quantity, a type, a difficulty, and a time schedule of the relay inspection task;
parsing feature information of the relay inspection task, wherein the feature information includes at least one of a regional feature, a difficulty feature, and a support demand feature;
filtering out research staff having a highest correlation with the relay inspection task by performing correlation analysis on the person segmentation level and the clustering label using the feature information as a first search target; and
adjusting research staff in the preset assignment information by using the filtered research staff.

12. The method according to claim 11, further comprising:
performing the correlation analysis on the person segmentation level and the clustering label to determine a correlation analysis result by using the feature information as the first search target; and
determining a plurality of groups of candidate assignment schemes for a target task based on the correlation analysis result and task information;
for each group of the plurality of groups of candidate assignment schemes:
determining a matching degree based on the correlation analysis result and the task information;
determining a team gain through a graph model based on a collaborative network map, wherein the graph model is a machine learning model;
determining a comprehensive score based on the matching degree and the team gain; and
determining a target assignment scheme based on the comprehensive score of each group of the plurality of groups of candidate assignment schemes.

13. The method according to claim 12, wherein the determining the matching degree includes:
determining the matching degree through a prediction model based on the task information, the person segmentation level, the clustering label, and a four-quadrant state, wherein the prediction model is a machine learning model.

14. The method according to claim 12, wherein the determining the target assignment scheme based on the comprehensive score of each group of the plurality of groups of candidate assignment schemes includes:
determining a plurality of optimal assignment schemes based on the comprehensive score;
for each optimal assignment scheme:
searching a personnel profile database for an inspection terminal sequence corresponding to research staff in each optimal assignment scheme;
sending a positioning request to a corresponding inspection terminal based on the inspection terminal sequence, and acquiring a current location of the research staff;
determining a location matching degree based on the current location of the research staff and a task execution location; and
determining the target assignment scheme based on the location matching degree of each optimal assignment scheme.

15. The method according to claim 11, further comprising:
searching a personnel profile database for contact information of an assigned person based on a target assignment scheme, wherein the assigned person refers to research staff corresponding to the target assignment scheme; and
sending assignment information to the assigned person based on the contact information of the assigned person.

16. The method according to claim 15, further comprising:
selecting a target inspection vehicle from an inspection vehicle database based on a current location of the assigned person and a task execution location, wherein a vehicle location of the target inspection vehicle satisfies a distance condition;
sending an authorization instruction to an access control system of the target inspection vehicle to change an entry permission of the assigned person from closed to open, thereby authorizing the assigned person to enter the target inspection vehicle; and
sending a configuration instruction to an inspection instrument in the target inspection vehicle to change an operation permission of the assigned person from closed to open, thereby authorizing the assigned person to operate the inspection instrument.
